(19) United States
(12) Patent Application Publication
(10) Pub. No.: US 2024/0289647 A1
(43) Pub. Date: Aug. 29, 2024

(54) KNOWLEDGE GRAPH PROCESSING

(71) Applicant: Alipay (Hangzhou) Information Technology Co., Ltd., Hangzhou (CN)

(72) Inventors: Deng ZHAO, Hangzhou (CN); Jianshan HE, Hangzhou (CN); Bin HU, Hangzhou (CN); Tao FANG, Hangzhou (CN); Zhizhen LIU, Hangzhou (CN); Zhengke GUI, Hangzhou (CN); Lei LIANG, Hangzhou (CN); Taifeng WANG, Hangzhou (CN); Wei CHU, Hangzhou (CN)

(21) Appl. No.: 18/572,718

(22) PCT Filed: Oct. 17, 2022
(86) PCT No.: PCT/CN2022/125693

§ 371 Date: Dec. 20, 2023

(30) Foreign Application Priority Data
Oct. 25, 2021 (CN) 202111243147.X

(51) Int. Cl. G06N 5/022

(52) U.S. Cl. CPC G06N 5/022

(57) ABSTRACT

A knowledge graph processing method is provided. The method includes: selecting several nodes and their edges from a shared knowledge graph based on one or more entity types involved in a target service domain, to obtain a target subgraph, where the shared knowledge graph is obtained by fusing knowledge graphs of one or more service domains; processing the target subgraph to extract one or more graph features, where the graph feature includes some or all of the following: a node representation vector, an edge representation vector, a graph structure feature, a semantic feature of graph text information, and a graph rule feature; and providing the graph feature to a target data processing task of the target service domain, where the graph feature is used to serve as an input feature of the target data processing task together with a task customization feature.

### TECHNICAL FIELD

This specification relates to the field of data processing technologies, and in particular, to a knowledge graph processing method and system.

### BACKGROUND

In various service domains, there is corresponding data. Each service domain needs to use data to implement a service task or target. For example, a training sample can be used to train a model to obtain a model with a capability of classification and relationship prediction. Knowledge graph data includes entities and relationships, and can cover more comprehensive or complete information. An ability to extract rich graph features from a knowledge graph and use them for tasks or targets in various service domains will help greatly improve working efficiency.

Therefore, a knowledge graph processing method and system are urgently needed to improve service application effects.

### SUMMARY

One aspect of this specification provides a knowledge graph processing method, including: selecting several nodes and their edges from a shared knowledge graph based on one or more entity types involved in a target service domain, to obtain a target subgraph, where the shared knowledge graph is obtained by fusing knowledge graphs of one or more service domains; processing the target subgraph to extract one or more graph features, where the graph feature includes some or all of the following: a node representation vector, an edge representation vector, a graph structure feature, a semantic feature of graph text information, and a graph rule feature; and providing the graph feature to a target data processing task of the target service domain, where the graph feature is used to serve as an input feature of the target data processing task together with a task customization feature, so as to implement the target data processing task.

Another aspect of this specification provides a knowledge graph processing system, including: a subgraph determining module, configured to select several nodes and their edges from a shared knowledge graph based on one or more entity types involved in a target service domain, to obtain a target subgraph, where the shared knowledge graph is obtained by fusing knowledge graphs of one or more service domains; a graph feature acquisition module, configured to process the target subgraph to extract one or more graph features, where the graph feature includes some or all of the following: a node representation vector, an edge representation vector, a graph structure feature, a semantic feature of graph text information, and a graph rule feature; and a task processing module, configured to provide the graph feature to a target data processing task of the target service domain, where the graph feature is used to serve as an input feature of the target data processing task together with a task customization feature, so as to implement the target data processing task.

Another aspect of this specification provides a knowledge graph processing apparatus, including at least one storage medium and at least one processor, where the at least one storage medium is configured to store computer instructions; and the at least one processor is configured to execute the computer instructions to implement the knowledge graph processing method.

### BRIEF DESCRIPTION OF DRAWINGS

This specification will be further illustrated by way of example embodiments that will be described in detail with reference to the accompanying drawings. These embodiments are not limiting. In these embodiments, the same reference numeral represents the same structure.

FIG. 1 is a schematic diagram illustrating an application scenario of a knowledge graph processing system, according to some embodiments of this specification;

FIG. 2 is a block diagram illustrating a knowledge graph processing system, according to some embodiments of this specification;

FIG. 3 is an example flowchart illustrating a knowledge graph processing method, according to some embodiments of this specification;

FIG. 4 is a schematic diagram illustrating a target subgraph processing method, according to some embodiments of this specification; and

FIG. 5 is a schematic diagram illustrating a shared knowledge graph, according to some embodiments of this specification.

### DESCRIPTION OF EMBODIMENTS

To describe the technical solutions in embodiments of this specification more clearly, the following briefly describes the accompanying drawings needed for describing the embodiments. Clearly, the accompanying drawings in the following description are merely some examples or embodiments of this specification. A person of ordinary skill in the art can still apply this specification to other similar scenarios based on these accompanying drawings without creative efforts. Unless clear from the language environment or otherwise stated, the same reference numeral in the figure represents the same structure or operation.

It should be understood that the terms “system”, “apparatus”, “unit”, and/or “module” used in this specification are used to distinguish between different components, elements, parts, portions, or assemblies of different levels. However, if other terms can achieve the same purpose, the term can be replaced by other expressions.

As shown in this specification and the claims, the terms “one”, “a”, and/or “the”, etc. may not be in a singular form, and may be in a plural form unless the context expressly suggests exceptions. Generally, the terms “include” and “contain” indicate only those steps and elements that have been explicitly identified, these steps and elements do not constitute an exclusive listing, and the method or device may also include other steps or elements.

A flowchart is used in this specification to describe operations performed by a system according to embodiments of this specification. It should be understood that the operations may not be accurately performed in sequence. Instead, the steps can be processed in reverse order or simultaneously. In addition, other operations can be added to these processes, or one or more operations can be removed from these processes.

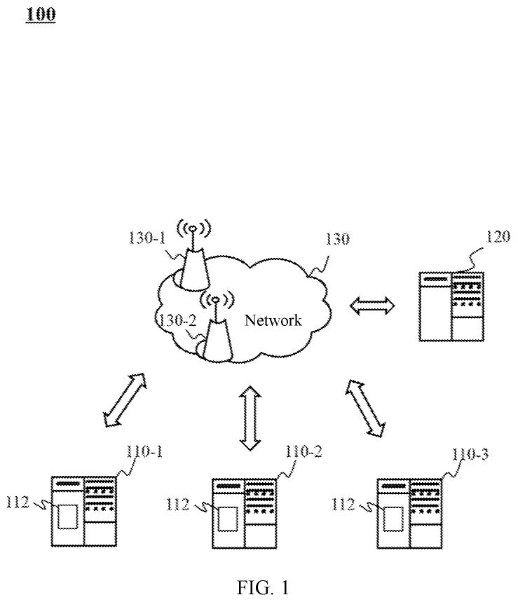

FIG. 1 is a schematic diagram illustrating an application scenario of a knowledge graph processing system, according to one or more embodiments of this specification.

An application scenario 100 can relate to various service scenarios in various service domains, for example, service domains such as security, insurance, payment, and wealth.

There are data processing tasks in various service scenarios in different service domains. For example, in a payment service domain, it is necessary to determine whether a plurality of payment accounts belong to a same merchant to clean belonging of a large quantity of payment accounts in service data. For another example, it can be determined whether a plurality of merchants belong to a same owner, so as to determine a service relationship between the merchants. In a specific data processing task, a service party may extract a task- related feature (or referred to as a task customization feature) based on data existing in a current service domain. For example, for determining whether a plurality of payment accounts belong to a data processing task of a same merchant, a service party can extract geographic location information of each payment account (which can be represented as a payment code form), and then determine, by using a distance between locations, which payment accounts belong to the same merchant (for example, there is a large probability that relatively close payment accounts belong to the same merchant). It can be considered that geographic location information is closely related to a task and is intuitively interpretable, and geographic location information can be considered as a task customization feature. However, in addition to such features closely associated with a task, relatively extensive and abstract auxiliary features can be excavated from a large quantity of service data. For example, each payment account can have a plurality of attributes, such as a registration time, a location, and a registration device identifier. Payment accounts belonging to a same merchant may have similar attribute distribution and payment relationship distribution. Therefore, if a knowledge graph can be constructed based on service data and a node representation vector of each payment node can be obtained, the node representation vectors can be used as auxiliary features to complete a data processing task together with a task customization feature (for example, a plurality of payment accounts belonging to a same merchant are determined with reference to a distance between geographic locations of payment accounts and similarity between the node representation vectors), and the auxiliary features can be used as a supplement to the task customization feature to further improve prediction accuracy.

In view of this, some embodiments of this specification propose to construct a knowledge graph according to an entity and/or a relationship related to a data processing task, and extract a graph feature for use by the data processing task, so as to improve service application efficiency. For each service domain, a data processing task can be performed based on a knowledge graph constructed by using data. In some embodiments, when performing a data processing task, each service domain can form, based on a service task or a service target, a link from knowledge graph data processing (for example, graph data processing and graph model training) to a service application. Different service applications need to establish a link from respective graph data processing to a service application. Work included in graph data processing of different service applications may be duplicated, causing waste of invested resources and labor. In addition, service data coverage in a single service domain is limited. If data in a plurality of service domains can be shared mutually, a data processing task can be more effectively and accurately implemented.

In view of the previous situation, some embodiments of this specification provide a knowledge graph processing method and system, and perform knowledge graph data processing based on a shared knowledge graph obtained by fusing knowledge graphs of one or more service domains, which includes: selecting several nodes and their edges from a shared knowledge graph based on one or more entity types involved in a target service domain, to obtain a target subgraph; processing the target subgraph to extract one or more graph features, where the graph feature can include: a node representation vector, an edge representation vector, a graph structure feature, a semantic feature of graph text information, and a graph rule feature; and then providing the graph feature to a target data processing task of the target service domain, where the graph feature is used to serve as an input feature of the target data processing task together with a task customization feature, so as to implement the target data processing task. According to the knowledge graph processing method and system provided in some embodiments of this specification, a knowledge graph of a data processing link in each service domain is constructed, and some graph features are extracted, which are implemented by a knowledge graph platform in a unified manner, to provide various graph features for each service domain, thereby effectively improving data processing efficiency and reducing resource and labor costs. In addition, the method or the system provided in this specification enables a target service party to introduce data in each service domain to perform a data processing task by using more complete knowledge graph data, so as to greatly improve implementation effects of a service task or target.

As shown in FIG. 1, the application scenario 100 of a knowledge graph processing system can include a plurality of servers such as 110-1, 110-2, and 110-3, a processing device 120, and a network 130.

The plurality of servers such as 110-1, 110-2, and 110-3 can respectively correspond to a plurality of platforms or service domains. The servers 110-1, 110-2, 110-3, and . . . can be configured to manage resources and process data and/or information, such as a plurality of graph features, from at least one component or external data source (for example, a cloud data center) of the system to implement various data processing tasks of the platform or the service domain. In some embodiments, each of the servers 110-1, 110-2, 110-3, and . . . can be a single server or a server group. The server group can be centralized or distributed (for example, the server 110-1 can be a distributed system), or can be dedicated or can provide a service simultaneously with another device or system. In some embodiments, the servers 110-1, 110-2, 110-3, and . . . can be regional or remote. In some embodiments, the servers 110-1, 110-2, 110-3, and . . . can be implemented on a cloud platform or provided in a virtual manner. By way of example only, the cloud platform can include a private cloud, a public cloud, a hybrid cloud, a community cloud, a distributed cloud, an internal cloud, a multi-tier cloud, etc., or any combination thereof.

In some embodiments, any one or more of the servers 110-1, 110-2, 110-3, and . . . can store data corresponding to a platform or a service domain, such as a data instance or a knowledge graph.

Any one or more of the servers 110-1, 110-2, 110-3, and . . . can include a processor 112. The processor 112 can process data and/or information obtained from another device or system component, such as a plurality of graph features. The processor can execute program instructions based on the data, the information, and/or a processing result to perform one or more functions described in this specification. In some embodiments, the processor 112 can include one or more sub-processing devices (for example, a single-core processing device or a multi-core processing device). As an example only, the processor 112 can include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction set computer (RISC), a microprocessor, or any combination thereof.

In some embodiments, the processing device 120 can correspond to a server of a knowledge graph platform. The processing device 120 can process data and/or information obtained from another device or system component. The processing device 120 can execute program instructions based on the data, the information, and/or a processing result to perform one or more functions described in this specification. For example, the processing device 120 can obtain two or more knowledge graphs from two or more of the servers 110-1, 110-2, 110-3, and . . . by using the network 130, to obtain a shared knowledge graph that integrates knowledge graphs of a plurality of service domains. The processing device 120 can select several nodes and their edges from the shared knowledge graph based on one or more entity types involved in the target service domain, to obtain the target subgraph, process the target subgraph to extract one or more graph features, and provide the graph feature for the servers 110-1, 110-2, 110-3, and . . . . In some embodiments, the processing device 120 can include one or more sub-processing devices (for example, a single-core processing device or a multi-core processing device). As an example only, the processing device 120 can include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction set computer (RISC), a microprocessor, or any combination thereof.

The network 130 can connect each component of the system and/or connect the system to an external part. The network 130 enables communication between the components of the system and between the system and an external part to facilitate exchange of data and/or information. In some embodiments, the network 130 can be any one or more of a wired network or a wireless network. For example, the network 130 can include a cable network, an optical fiber network, a telecommunications network, the Internet, a local area network (LAN), a wide area network (WAN), a wireless local area network (WLAN), a metropolitan area network (MAN), a public switched telephone network (PSTN), a Bluetooth network, ZigBee, near field communication (NFC), an in-device bus, an in-device line, a cable connection, or any combination thereof. In some embodiments, a network connection between the parts of the system can be in one of the previous manners, or can be in a plurality of manners thereof. In some embodiments, the network 130 can be a combination of various topologies, such as point-to-point, shared, or central topologies. In some embodiments, the network 130 can include one or more network access points. For example, the network 130 can include a wired or wireless network access point, such as a base station and/or network switching points 130-1, 130-2, and. . . . Through these network access points, one or more components of the system can be connected to the network 130 to exchange data and/or information.

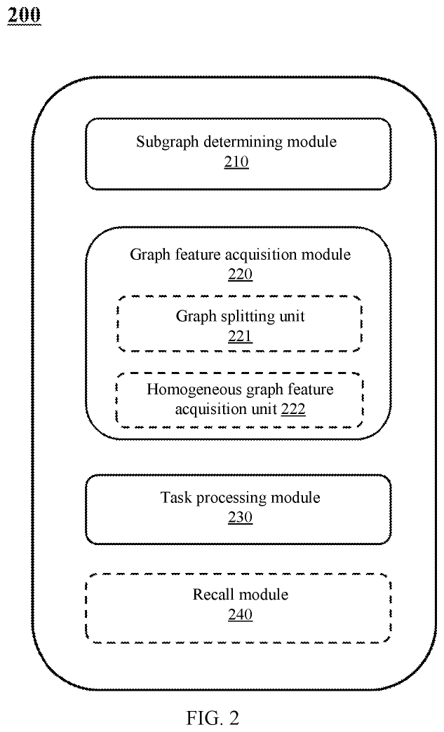

FIG. 2 is a block diagram illustrating a knowledge graph processing system, according to some embodiments of this specification.

In some embodiments, the knowledge graph processing system 200 can be implemented on a processing device 120.

In some embodiments, the knowledge graph processing system 200 can include a subgraph determining module 210, a graph feature acquisition module 220, and a task processing module 230. In some embodiments, the knowledge graph processing system 200 can further include a recall module 240. In some embodiments, the graph feature acquisition module 220 can further include a graph splitting unit 221 and a homogeneous graph feature acquisition unit 222.

In some embodiments, the subgraph determining module 210 can be configured to select several nodes and their edges from a shared knowledge graph based on one or more entity types involved in a target service domain, to obtain a target subgraph, where the shared knowledge graph is obtained by fusing knowledge graphs of one or more service domains. In some embodiments, the subgraph determining module 210 can be further configured to: obtain a macro feature of the target subgraph, where the macro feature includes one or more of the following: a quantity of entities, degree distribution of a graph, connectivity distribution of a graph, and a data quality score of a graph; and determine, based on the macro feature, whether the target subgraph satisfies a requirement, and if the target subgraph does not satisfy the requirement, modify the target subgraph or re-obtain a target subgraph from the shared knowledge graph.

In some embodiments, the graph feature acquisition module 220 can be configured to process the target subgraph to extract one or more graph features, where the graph feature includes some or all of the following: a node representation vector, an edge representation vector, a graph structure feature, a semantic feature of graph text information, and a graph rule feature. In some embodiments, the graph structure feature includes one or more of the following: degree information, a PageRank value, a node clustering coefficient, closeness centrality, eigenvector centrality, a common neighbor indicator, a Katz indicator, and random walk similarity.

In some embodiments, the target subgraph can be a heterogeneous graph. In some embodiments, the graph splitting unit 221 can be configured to split the target subgraph into a plurality of homogeneous graphs.

In some embodiments, the homogeneous graph feature acquisition unit 222 can be configured to separately process the homogeneous graph to extract one or more graph features.

In some embodiments, the task processing module 230 can be configured to provide the graph feature to a target data processing task of the target service domain, where the graph feature is used to serve as an input feature of the target data processing task together with a task customization feature, so as to implement the target data processing task. In some embodiments, the target data processing task is entity classification, inter-entity relationship prediction, or entity set mining.

In some embodiments, the recall module 240 can be configured to: recall several candidate nodes from the shared knowledge graph based on the target data processing task, where the candidate node is a processing object of the target data processing task; and a recall manner includes: querying the shared knowledge graph based on a retrieval condition to obtain the candidate node, or obtaining the candidate node from the shared knowledge graph through vector retrieval based on a target vector.

It should be understood that the system shown and the modules thereof can be implemented in various forms. For example, in some embodiments, the system and the modules of the system can be implemented by hardware, software, or a combination of software and hardware. The hardware part can be implemented by using dedicated logic. The software part can be stored in a memory and executed by an appropriate instruction execution system, for example, a microprocessor or specially designed hardware. A person skilled in the art can understand that the above methods and systems can be implemented by using computer-executable instructions and/or control code included in the processor. For example, such code is provided on a carrier medium such as a disk, a CD, or a DVD-ROM, a programmable memory such as a read-only memory (firmware), or a data carrier such as an optical or electronic signal carrier. The system and the modules of the system in this specification can be implemented not only by a hardware circuit of an ultra-large-scale integrated circuit or gate array, a semiconductor such as a logic chip or a transistor, or a programmable hardware device such as a field programmable gate array or a programmable logic device, but also by software executed by various types of processors, or can be implemented by a combination (for example, firmware) of the hardware circuit and software.

It is worthwhile to note that the previous descriptions of the system and its modules are for ease of description only, and this specification should not be limited to the scope of the enumerated embodiments. It can be understood that, after understanding the principle of the system, a person skilled in the art can randomly combine the modules or form a subsystem to be connected to another module without departing from the principle.

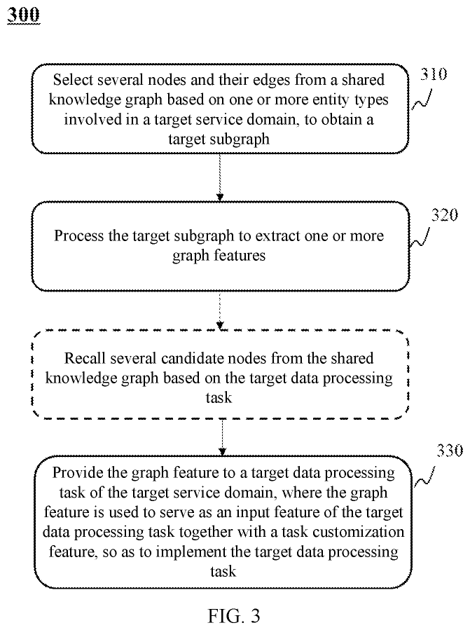

FIG. 3 is an example flowchart illustrating a knowledge graph processing method, according to some embodiments of this specification.

In some embodiments, a method 300 can be performed by a processing device 120. In some embodiments, the method 300 can be implemented by the knowledge graph processing system 200 deployed on the processing device 120.

As shown in FIG. 3, the method 300 can include the following steps:

Step 310: Select several nodes and their edges from a shared knowledge graph based on one or more entity types involved in a target service domain, to obtain a target subgraph.

In some embodiments, step 310 can be performed by the subgraph determining module 210.

A knowledge graph is a knowledge base composed of a series of nodes representing entities and edges representing relationships between the entities.

An entity is an extensive abstraction of an objective individual. The entity can refer to a tangible object in a physical world, for example, a natural person, an automobile, or a merchant, or can refer to an intangible object, for example, a payment account, an identity, a Wi-Fi account, funds, or program code. An entity can have a plurality of types, such as a natural person, a merchant, a payment account, an identity, and a Wi-Fi account. Each entity can correspond to a plurality of entity instances. For example, a natural person entity can include data instances such as Zhang San, Li Ming, and Wang Nian.

There can be a relationship between entities. For example, there is a business relationship between a merchant A and a merchant B, a merchant C is a child merchant of the merchant A, and Zhang San is a manager of the merchant A. An inter-entity relationship can have a plurality of types, for example, a belonging relationship, an employment relationship, and a payment relationship.

A shared knowledge graph refers to a knowledge graph that can be used for a plurality of service domains. In some embodiments, the shared knowledge graph can be obtained by fusing two or more knowledge graphs. Data in the shared knowledge graph can be from one service domain or can be from a plurality of service domains. In some embodiments, the plurality of service domains can be related service domains, such as financial, payment, security, or similar or cross-cutting service domains.

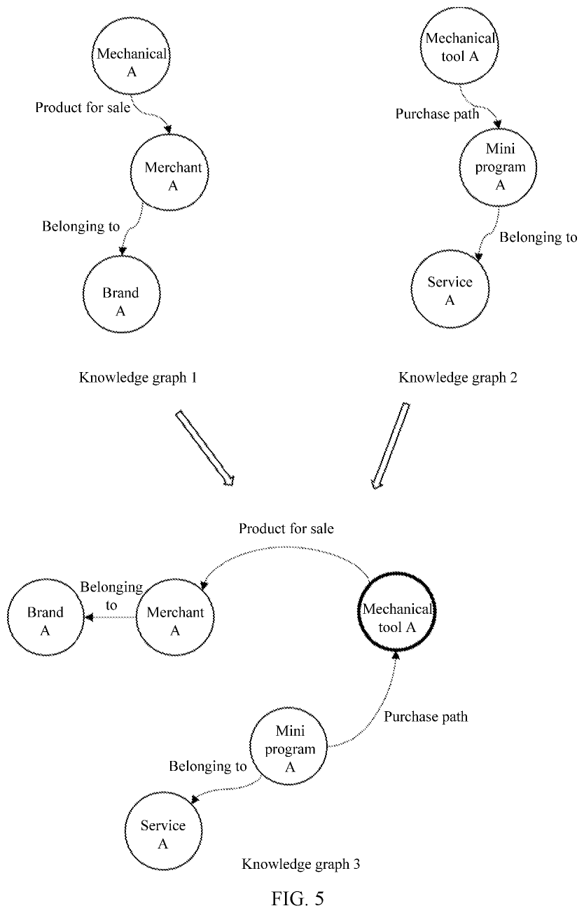

In some embodiments, the shared knowledge graph can be obtained by fusing knowledge graphs of a plurality of service domains (for example, insurance and payment). Specifically, knowledge graphs of a plurality of service domains can be obtained, and node attributes or edge attributes in each knowledge graph are normalized by using an attribute normalization operator, or same nodes in knowledge graphs are fused by using an entity fusion operator, or a new relationship is established between nodes by using a linking operator, etc. As shown in FIG. 5, a knowledge graph 1 and a knowledge graph 2 can be fused, where mechanical A and a mechanical tool A are fused into one entity mechanical tool A to obtain a shared knowledge graph 3 including the two knowledge graphs, and graph data of the two knowledge graphs is unified for expression and connected for sharing.

In general, shared knowledge graph data covers a wide range, but it also has a large scale. For example, a quantity of nodes reaches hundreds of billions. The target service domain refers to a service domain corresponding to a to-be-performed service application. The target service domain can be one of a plurality of service domains involved in graph fusion, or can be another service domain. In a service domain, one or more entity types can be involved. For example, in the payment field, a plurality of entity types such as a merchant, a natural person, a payment account, an identity, a business license, a mobile number, etc. are involved. In some embodiments, a plurality of entity types involved in the target service domain can be determined based on a data processing task common to the target service domain, and the several nodes and their edges are selected from the shared knowledge graph based on one or more entity types involved in the target service domain.

Based on one or more entity types involved in the target service domain, selecting several nodes and their edges from the shared knowledge graph means selecting nodes of an entity type involved in the corresponding target service domain from the shared knowledge graph and edges associated with these nodes. For example, the target service domain is the payment field, and involved entity types include a merchant, a natural person, a payment account, an identity, a business license, and a mobile number. A node corresponding to an entity belonging to a merchant (such as a first convenience store or a second supermarket), an entity belonging to a natural person (such as Zhang San, Li Ming, and Wang Nian), an entity belonging to a payment account (such as an account 51522 and an account 51324), an entity belonging to an identity (such as an identity 3123 and an identity 3224), an entity belonging to a business license (such as a business license number 321 and a business license number 311), an entity belonging to a mobile number (such as a mobile number 212367 and a mobile number 212346), and edges associated with these nodes can be selected.

In some embodiments, the selected several nodes and edges can include entity types and inter-entity relationships involved in or related to a plurality of data processing tasks of the target service domain. For example, in the payment field, the data processing task can include: determining whether a plurality of payment accounts belong to a same merchant, determining whether a plurality of merchants belong to a same operator, etc. In this case, the several selected nodes and edges include nodes and edges corresponding to an entity type and an inter-entity relationship involved in or related to the data processing task.

In some embodiments, required nodes and edges can be selected from the shared knowledge graph by using various selection methods. For example, the shared knowledge graph can be queried based on a search condition such as an entity type and relationship information to obtain a required node and edge.

In this specification, a knowledge graph formed by several nodes and edges selected from a shared knowledge graph based on one or more entity types involved in a target service domain can be referred to as a target subgraph.

In some embodiments, after the target subgraph is obtained, a macro feature of the target subgraph can be obtained. A macro feature is a feature that can reflect an overall characteristic or statistical information of a graph. In some embodiments, the macro feature can include one or more of the following: a quantity of entities, degree distribution of a graph, connectivity distribution of a graph, a data quality score of a graph, etc.

The quantity of entities refers to a quantity of entities included in a graph, for example, 10,000. The quantity of entities can reflect a data scale of the target subgraph. The degree distribution of a graph refers to a situation of a degree of each node or entity in the graph. The degree refers to a quantity of edges connected to one node, and also refers to a quantity of other nodes connected to one node. The degree can include an outgoing degree and an incoming degree. The outgoing degree refers to a quantity of edges that point to another node from the node. The incoming degree refers to a quantity of edges that point to the node. The degree distribution can reflect hotspot distribution of a graph (such as the target subgraph). The connectivity distribution of a graph refers to distribution of a connectivity degree of each node. Connectivity refers to a case in which there is a reachable edge between nodes. A node in a region with better connectivity has wider association or fuller association, and a node in a region with worse connectivity has relatively single association. The data quality score of a graph refers to a score of data quality of a node and an edge of a graph. Larger data vacancy and/or lower data accuracy indicates a lower data quality score.

In some embodiments, the target subgraph can be evaluated based on the macro feature of the target subgraph. In some embodiments, whether the target subgraph satisfies a requirement can be determined based on the macro feature, for example, whether the quantity of entities is greater than a threshold, whether the degree distribution of a graph satisfies a condition, whether the connectivity distribution of a graph satisfies a condition, and whether the data quality score of a graph is greater than a threshold. The requirement can be determined according to an actual requirement or experience, which is not limited in this embodiment.

In some embodiments, if it is determined based on the macro feature that the target subgraph does not satisfy the requirement, the target subgraph can be modified (for example, supplementing a node, an edge, related information of an entity corresponding to a node, or related information of an inter-entity relationship corresponding to an edge) or a target subgraph can be re-obtained from the shared knowledge graph based on a new retrieval condition to obtain a target subgraph that satisfies the requirement.

Step 320: Process the target subgraph to extract one or more graph features.

In some embodiments, step 320 can be performed by the graph feature acquisition module 220.

The graph feature refers to feature information included in the knowledge graph, and can include some or all of the following: a node representation vector, an edge representation vector, a graph structure feature, a semantic feature of graph text information, and a graph rule feature.

The node representation vector is a vector used to represent node information (such as a node type and node attribute information), and the edge representation vector is a vector used to represent edge information (such as an edge type and edge attribute information). In some embodiments, expression learning can be performed on the target subgraph by using a graph neural network model such as GNN, GCN, and Graph LSTM, to obtain a node representation vector of each node and an edge representation vector of each edge.

The graph structure feature is a structure information feature in a graph and can describe structure information with a specific meaning.

In some embodiments, the graph structure feature can include one or more of the following: degree information, a PageRank value, a node clustering coefficient, closeness centrality, eigenvector centrality, a common neighbor indicator, a Katz indicator, random walk similarity, etc. In some embodiments, the graph structure feature can be obtained by using statistics, a graph structure algorithm, model calculation, etc.

The degree information refers to information about a degree of a node. The degree refers to a quantity of edges connected to one node, and also refers to a quantity of other nodes connected to one node. The degree Can include an outgoing degree and an incoming degree. The outgoing degree refers to a quantity of edges that point to another node from the node. The incoming degree refers to a quantity of edges that point to the node.

The PageRank value is an indicator used to represent importance of a node in a graph. In some embodiments, the PageRank value of the node can be determined based on a case of an edge connected to the node and a PageRank value of another node connected to the node. For example, if node Zhang San is connected to an edge, a score of the node can be increased. If node Zhang San is not connected to an edge, the score of the node can be decreased, and PageRank values of neighboring nodes of node Zhang San are weighted and averaged to obtain a score of node Zhang San. Based on the weighted and averaged score of the neighboring nodes, the increased score, and the decreased score, a comprehensive score of node Zhang San can be obtained and used as a PageRank value of node Zhang San.

The node clustering coefficient is an indicator used to describe a degree of association between adjacent nodes of a node. For example, the node clustering coefficient is used to describe a degree of interconnection between adjacent nodes of a node. The more edges between adjacent nodes, the higher the node clustering coefficient. As an example, a plurality of fans are adjacent nodes of a celebrity A, but there is little or no association between the fans, and a node clustering coefficient of node celebrity A is relatively low.

The closeness centrality is an indicator used to indicate a length of a path from one node to another node, and can be represented by using an average shortest path from one node to all other nodes. The smaller the value of the average shortest path, the shorter the path from this point to all other points, which indicates that the node is closer to all other nodes.

The eigenvector centrality (or referred to as feature vector centrality) is used to represent the likelihood that a node is accessed under random walk of an infinite length. The eigenvector centrality can be represented by a feature vector score of a node. A node connected to another neighboring node with a higher eigenvector score can have a higher score than a node connected to a neighboring node with a lower eigenvector score. A higher feature vector score can indicate that the node is connected to many nodes whose feature vector scores are higher, that is, closer to the center.

The common neighbor indicator is an indicator used to represent a potential relationship and closeness between two nodes. The common neighbor indicator can be obtained by using various common neighbor algorithms, for example, a common neighbor algorithm is used to obtain a neighboring node common to two nodes, and a potential relationship and closeness between the two nodes are further estimated based on the neighboring node.

The Katz indicator is used to describe a quantity of paths from one node to another node. For example, a set of all paths from one node to another node can be obtained, and a sum of path lengths from one node to another node can be obtained, to obtain a path length from one node to another node (for example, if one node A passes through three edges to reach another node B, a set of paths from node A to node B is three paths, and a length of one path can be considered as 1; and a sum of path lengths in the set of paths is obtained to obtain a path length from node A to node B as 3), and a corresponding Katz value can be obtained based on the path length.

The random walk similarity refers to inter-node similarity determined based on a random walk manner in which multi-step random walk is performed along a randomly selected adjacent edge starting from a specific node to reach another node. In some embodiments, the random walk similarity can be calculated by using a random walk model, a local random walk model, etc. For example, a transfer probability vector of a node can be obtained by using a random walk model, and similarity between two nodes can be obtained by calculating relative entropy of transfer probability vectors of the two nodes. The transfer probability is a probability of reaching another node of a network after multi-step random walk is performed starting from a specific node, and the transfer probability vector is a vector representation of a probability of reaching all other nodes of the network after multi-step random walk is performed starting from a specific node.

The semantic feature of graph text information refers to a semantic feature of text information (such as attribute information of a node and attribute information of an edge) in graph data. In some embodiments, the semantic feature of graph text information can be obtained by using various methods such as a natural language processing model, a feature extraction algorithm, or a feature representation algorithm. For example, a corresponding text representation vector can be obtained by inputting text information into a natural language processing model such as BERT, RNN, Transformer, and ESIM, so as to represent a semantic feature of the text information by using the text representation vector.

The graph rule feature refers to features of various graph rules. The graph rule refers to a law of a related rule or graph data of a node or an edge, and can be used for reasoning, decision-making, and verification of a service, or can be used as a constraint. For example, father's father is grandfather, and an enterprise can have only one legal person, and both are graph rules. In some embodiments, the graph rule feature can be obtained by means of manual mining. For another example, the graph rule feature can be obtained by using a rule mining algorithm such as SFE.

According to this embodiment, a plurality of and diversified graph features can be uniformly obtained for various data processing tasks common to the target service domain. The plurality of graph features such as graph structure features, graph rule features, and semantic features can provide specific meanings for feature information of graphs, so the graph features are more representational and interpretable.

In some embodiments, the target subgraph can include a plurality of different types of nodes corresponding to a plurality of different types of entities (such as a person, a payment account, and a Wi-Fi account) and a plurality of different types of edges corresponding to a plurality of different types of inter-entity relationships (such as a belonging relationship, an employment relationship, and a payment relationship), that is, the target subgraph is a heterogeneous graph.

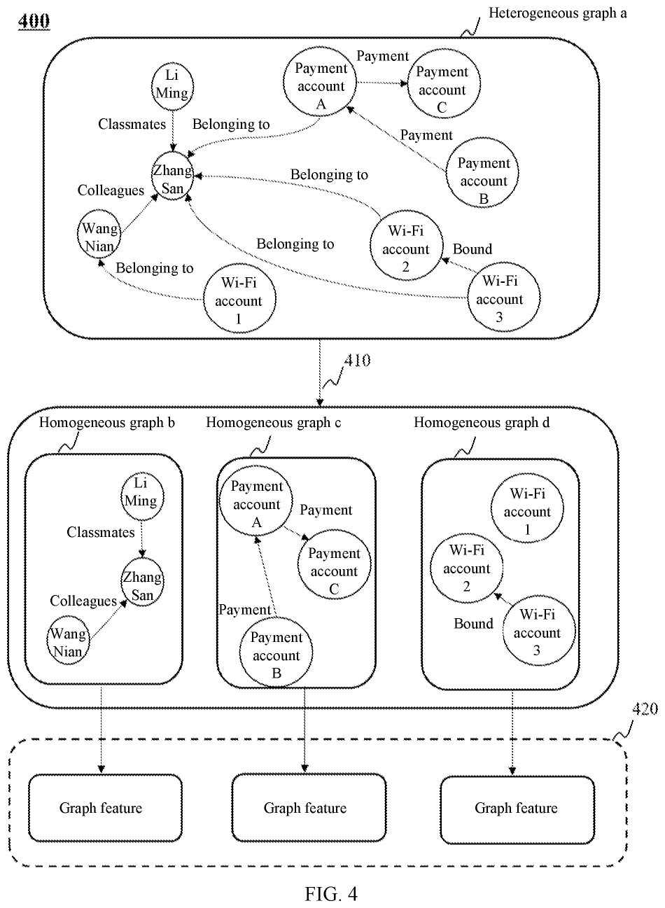

In some embodiments, when the target subgraph is a heterogeneous graph, the target subgraph can be split into a plurality of homogeneous graphs, and the homogeneous graphs are separately processed to extract one or more graph features. For more specific content of splitting the target subgraph into a plurality of homogeneous graphs to extract one or more graph features, refer to FIG. 4 and related descriptions thereof.

Step 330: Provide the graph feature to a target data processing task of the target service domain, where the graph feature is used to serve as an input feature of the target data processing task together with a task customization feature, so as to implement the target data processing task.

In some embodiments, step 330 can be performed by the task processing module 230.

The target data processing task is a to-be-performed data processing task, and can include various data processing tasks of a service application.

In some embodiments, the target data processing task can be entity classification, inter-entity relationship prediction, entity set mining, etc.

Entity classification is a task that classifies entities (such as binary classification and multi-classification). For example, for an entity XX technology company, a corresponding risk category is determined.

Inter-entity relationship prediction is a task that predicts an inter-entity association relationship. For example, for an entity Zhang San and a plurality of enterprises, an association relationship between Zhang San and the enterprise is predicted, so as to obtain which enterprise Zhang San is employed. For another example, for a plurality of payment accounts, an association relationship between the plurality of payment accounts is predicted to determine whether the plurality of payment accounts belong to a same merchant.

Entity set mining refers to mining an entity set formed by a plurality of entities, so as to understand related group information such as a group situation and a role of each entity in the group. For example, for an entity set formed by a plurality of natural persons, it is determined whether the plurality of persons are a criminal group, and which of the plurality of persons are core members of the group is determined.

In some embodiments, the target data processing task can be implemented by using various task processing methods, such as a graph reasoning method and a model prediction method. This is not limited in this embodiment.

In some embodiments, the obtained one or more graph features are provided to the target service domain. In the graph features, the target service party can select one or more graph features (for example, a node representation vector and an edge representation vector, or one or more graph structure features, or a node representation vector, an edge representation vector, and a graph rule feature, or a node representation vector, an edge representation vector, and a semantic feature) that can be used for the target data processing task and use the selected graph feature as an input feature of the target data processing task, so as to implement the target data processing task to obtain a processing task result.

In some embodiments, the selected graph feature and a task customization feature can be used together as input features of the target data processing task, so as to implement the target data processing task to obtain a processing task result.

In the target service domain, the graph feature is used as an input supplement or background knowledge, and a feature corresponding to the graph feature is a task customization feature. The task customization feature is obtained by performing targeted feature extraction on existing data in the target service domain based on the target data processing task. Generally, the task customization feature is more relevant to the target data processing task or is more intuitively interpretable to the processing result. In some embodiments, an input feature of the target data processing task other than a graph feature provided by a knowledge graph platform can be referred to as a task customization feature. In other words, the task customization feature is generally generated in the target service domain, or is extracted by the target service party according to the target data processing task. To some extent, it can be understood that different target data processing tasks have different task customization features, but can be shared as auxiliary graph features. For an example description of the task customization feature, refer to related content in FIG. 1. Details are omitted here for simplicity.

As an example, the target data processing task is to determine whether a plurality of payment accounts belong to a same merchant, and can select, from a plurality of obtained graph features, a graph structure feature (for example, reflecting whether terminal devices that transfer money to the payment account are connected to a same medium such as Wi-Fi), a graph rule feature, and a semantic feature, and use the selected graph feature and a task customization feature together as input features of the target data processing task, so as to determine whether the plurality of payment accounts belong to the same merchant. For another example, for a type annotation of a participle in a text, in addition to using a semantic feature of the participle (that is, a task customization feature), a node representation vector corresponding to a participle in a synonym graph can be further obtained, and used as auxiliary information, which is used as an input feature of a participle type annotation together with the semantic feature. According to this embodiment, a target subgraph related to a target service domain is constructed and a plurality of graph features are generated, which can bring benefits to a specific processing task in the service domain, and more efficiently and effectively complete a data processing task, to obtain a more accurate task result. In addition, based on a graph feature having a specific meaning, such as a graph structure feature, a graph rule feature, and a semantic feature, an explanation can be provided for impact or a function of various types of data information on a data processing task result, and an implementation effect of a task (for example, accuracy of a prediction task or an identification task) can be further improved.

In some embodiments, implementation of the target data processing task can further include: recalling several candidate nodes from the shared knowledge graph based on the target data processing task, so as to perform the target data processing task on the candidate nodes to obtain a processing task result for the candidate nodes. For example, for a target data processing task that needs to predict which company Zhang San is employed, to reduce data processing pressure, a plurality of candidate company nodes that Zhang San may be employed can be selected from a shared knowledge graph based on a specific principle. Then, personal information of Zhang San and a related feature of each candidate node can be obtained as task customization features, a graph structure feature between a natural person and a company node can be obtained from the graph features as auxiliary information, and a company in which Zhang San is employed is further predicted from a plurality of candidate company nodes. In other words, the candidate node can be a processing object of the target data processing task. For another example, a plurality of groups of nodes can be obtained from the shared knowledge graph to obtain a plurality of candidate node sets, so as to predict properties of these candidate node sets. In some embodiments, recalling of the candidate node can be performed by the recall module 240.

In some embodiments, the candidate node can be obtained by querying the shared knowledge graph based on a retrieval condition. For example, the recall module 240 can query a plurality of company nodes with same geographic information from the shared knowledge graph based on residence information of Zhang San as candidate nodes. For another example, the recall module 240 can query a plurality of groups of nodes with relatively large node clustering coefficients from the shared knowledge graph, so as to obtain a plurality of candidate node sets.

In some embodiments, the candidate node can alternatively be obtained from the shared knowledge graph by vector retrieval based on a target vector. For example, the target data processing task is to determine whether a plurality of payment accounts belong to a same merchant, and can determine a target payment account (for example, a payment account of a target merchant), generate a corresponding feature representation vector, that is, a target vector, for the target payment account, match the target vector against a node representation vector of each node in a knowledge graph, to obtain a node representation vector that matches or is similar to the target vector (for example, a vector distance is less than a specified threshold), and use a payment account node corresponding to a matched or similar node representation vector as a candidate node.

In some embodiments, a node representation vector of each node (including a payment account node) in the graph can be obtained by representation learning of the graph. Because the node representation vector fuses information about a neighboring node or an edge of each node and a plurality of graph features such as a graph structure feature, matching accuracy and coverage can be improved, thereby improving accuracy and coverage of recalling of a candidate node. In addition, a recall time can be greatly shortened based on vector retrieval, and working efficiency can be further improved.

FIG. 4 is a schematic diagram illustrating a target subgraph processing method, according to some embodiments of this specification.

In some embodiments, the method 400 can be implemented by the processing device 120. In some embodiments, the method 400 can be implemented by the graph splitting unit 221 and the homogeneous graph feature acquisition unit 222 in the knowledge graph processing system 200.

As shown in FIG. 4, the method 400 can include the following steps:

Step 410: Split a target subgraph into a plurality of homogeneous graphs.

In some embodiments, step 410 can be performed by the graph splitting unit 221.

In some embodiments, the target subgraph is a heterogeneous graph, and the target subgraph can be split into a plurality of homogeneous graphs, where the homogeneous graph refers to a knowledge graph that includes only one entity type and one relationship type. For example, the target subgraph is a heterogeneous graph a that includes several entity types such as a person, a payment account, and a Wi-Fi account, and a plurality of types of relationships between these entities. The target subgraph a can be split into the following several homogeneous graphs: a homogeneous graph (which can be referred to as a social graph) b that includes only a human and an interpersonal relationship, a homogeneous graph (which can be referred to as a payment graph) c that includes only a payment account and a payment relationship between payment accounts, and a homogeneous graph (which can be referred to as a medium graph) d that includes only a Wi-Fi account and a binding relationship between Wi-Fi accounts.

In some embodiments, the target subgraph as a heterogeneous graph can be split into a plurality of homogeneous graphs by using various graph splitting methods or graph extraction methods. For example, nodes of a same entity type and edges of a same relationship type can be extracted, so as to construct a corresponding homogeneous graph.

Step 420: Process the homogeneous graphs to extract one or more graph features.

In some embodiments, step 420 can be performed by the homogeneous graph feature acquisition unit 222.

In some embodiments, graph data processing can be performed on the homogeneous graphs obtained by means of splitting, so as to extract a plurality of graph features. For more content of the method for performing graph data processing on the graph to obtain a plurality of graph features, refer to step 320 and related description. Details are omitted here for simplicity. For a plurality of different homogeneous graphs, graph data processing can be separately performed on the plurality of homogeneous graphs to obtain a plurality of corresponding set of graph features (one set of graph features can include one or more graph features of the homogeneous graph).

For different homogeneous graphs, they can have different graph structure meanings (for example, a social relationship structure of a person, a payment relationship structure of a payment account, and a relationship structure of a Wi-Fi account), and corresponding graph features can represent different graph structure meanings. According to this embodiment, for the target subgraph that is used as a heterogeneous graph, a plurality of sets of graph features that are more detailed and specific and have a plurality of different structure meanings can be obtained.

It is worthwhile to note that, the above descriptions of the procedures and the methods are merely for example and description, and do not limit the applicable scope of this specification. A person skilled in the art can make various amendments and changes to the procedures and the methods under the guidance of this specification. However, these modifications and changes still fall within the scope of this specification. For example, the sequence of steps in the procedures and the methods is changed, the steps in different procedures and methods are combined, etc.

An embodiment of this specification further provides a knowledge graph processing apparatus, including at least one storage medium and at least one processor, where the at least one storage medium is configured to store computer instructions; and the at least one processor is configured to execute the computer instructions to implement a knowledge graph processing method. The method can include: selecting several nodes and their edges from a shared knowledge graph based on one or more entity types involved in a target service domain, to obtain a target subgraph, where the shared knowledge graph is obtained by fusing knowledge graphs of more service domains; processing the target subgraph to extract one or more graph features, where the graph feature includes some or all of the following: a node representation vector, an edge representation vector, a graph structure feature, a semantic feature of graph text information, and a graph rule feature; and providing the graph feature to a target data processing task of the target service domain, where the graph feature is used to serve as an input feature of the target data processing task together with a task customization feature, so as to implement the target data processing task.

Beneficial effects that can be brought by this embodiment of this specification include but are not limited to: (1) When a data processing task is performed based on a knowledge graph, a shared knowledge graph obtained by fusing data of a plurality of service domains is used to perform the data processing task by using more complete knowledge graph data, and various types of information included in the knowledge graph data are more effectively used to obtain a plurality of and diversified graph features. For different service applications, a required graph feature can be selected therefrom to implement a target data processing task by using more complete data, which can greatly improve an implementation effect of a service task or target. (2) Based on a target subgraph determined from the shared knowledge graph, a plurality of and diversified graph features with specific meanings are obtained, such as a graph structure feature, a graph rule feature, and a semantic feature, which can provide an explanation for impact or functions of various data information in a service application result, and can effectively help further improve an implementation effect of a service task or target (for example, accuracy of a prediction task or an identification task). It is worthwhile to note that beneficial effects that can be generated in different embodiments are different. The beneficial effects that can be generated in different embodiments can be any one or a combination of several of the above beneficial effects, or can be any other beneficial effect possibly achieved.

Basic concepts have been described above. Clearly, for a person skilled in the art, the above detailed disclosure is merely an example, but does not constitute a limitation on this specification. Although not expressly stated here, a person skilled in the art may make various modifications, improvements, and amendments to this specification. Such modifications, improvements, and amendments are proposed in this specification. Therefore, such modifications, improvements, and amendments still fall within the spirit and scope of the example embodiments of this specification.

In addition, specific words are used in this specification to describe the embodiments of this specification. For example, terms such as “one embodiment”, “an embodiment”, and/or “some embodiments” mean a certain feature, structure, or characteristic related to at least one embodiment of this specification. Therefore, it is worthwhile to emphasize and note that “one embodiment”, “an embodiment”, or “an alternative embodiment” mentioned twice or more times in different locations in this specification does not necessarily refer to the same embodiment. In addition, some features, structures, or characteristics in one or more embodiments of this specification can be appropriately combined.

In addition, a person skilled in the art can understand that the aspects of this specification can be illustrated and described by using several patentable categories or cases, including a combination of any new and useful processes, machines, products, or substances, or any new and useful improvements to the processes, machines, products, or substances. Correspondingly, the aspects of this specification can be executed by hardware only, can be executed by software (including firmware, resident software, microcode, etc.) only, or can be executed by a combination of hardware and software. The above hardware or software can be referred to as a “data block”, a “module”, an “engine”, a “unit”, a “component”, or a “system”. In addition, the aspects of this specification may be represented by a computer product located in one or more computer-readable media, and the product includes computer-readable program code.

The computer storage medium may include a propagated data signal that includes computer program code, for example, located on a baseband or used as a part of a carrier. The propagated signal may have a plurality of representation forms, including an electromagnetic form, an optical form, etc., or an appropriate combination form. The computer storage medium can be any computer-readable medium other than a computer-readable storage medium. The medium can be connected to an instruction execution system, apparatus, or device to implement communication, propagation, or transmission of a program for use. The program code located on the computer storage medium can be propagated through any appropriate medium, including radio, a cable, a fiber cable, RF, or similar media, or any combination of the above media.

The computer program code needed for operation of each part of this specification can be written in any one or more programming languages, including object-oriented programming languages such as Java, Scala, Smalltalk, Eiffel, JADE, Emerald, C++, C #, VB.NET, and Python, conventional programming languages such as the C language, Visual Basic, Fortran 2003, Perl, COBOL 2002, PHP, ABAP, and dynamic programming languages such as Python, Ruby, and Groovy, or other programming languages. The program code can be run entirely on a user computer, or run as an independent software package on a user computer, or run partially on a user computer and partially on a remote computer, or run entirely on a remote computer or a processing device. In the latter case, the remote computer can be connected to a user computer through any form of network, such as a local area network (LAN) or a wide area network (WAN), or connected to an external computer (for example, through the Internet), or in a cloud computing environment, or used as a service, such as software as a service (SaaS).

In addition, unless expressly stated in the claims, the order of the processing elements and sequences, the use of numerals and letters, or the use of other names described in this specification is not intended to limit the order of the procedures and methods described in this specification. Although some embodiments of this specification considered useful currently are discussed by using various examples in the above disclosure, it should be understood that such details are merely used for illustration. The additional claims are not limited to the disclosed embodiments, and instead, the claims are intended to cover all amendments and equivalent combinations that conform to the essence and scope of the embodiments of this specification. For example, although the system components described above can be implemented by hardware devices, the system components can also be implemented only by software solutions. For example, the described system is installed on existing processing devices or mobile devices.

Similarly, it is worthwhile to note that, to simplify the description disclosed in this specification and help understand one or more embodiments of this specification, in the above descriptions of the embodiments of this specification, a plurality of features are sometimes incorporated into one embodiment, drawing, or descriptions of the embodiment and the drawing. However, the present disclosure method does not mean that features needed by the object in this specification are more than the features mentioned in the claims. In fact, the features of the embodiments are less than all features of individual embodiments disclosed above.

Numerals describing quantities of components and attributes are used in some embodiments. It should be understood that such numerals used for the description of the embodiments are modified in some examples by modifiers such as “about”, “approximately”, or “generally”. Unless otherwise stated, “about”, “approximately”, or “generally” indicates that a change of ±20% is allowed for the numeral. Correspondingly, in some embodiments, numeric parameters used in this specification and the claims are approximations, and the approximations can change based on features needed by some embodiments. In some embodiments, the numeric parameters should take into account the specified significant digits and use a general digit retention method. Although in some embodiments of this specification, numeric domains and parameters used to determine the ranges of the embodiments are approximations, in specific implementations, such values are set as precisely as possible in a feasible range.

Each patent, patent application, and patent application publication and other materials such as articles, books, specifications, publications, or documents are incorporated into this specification here by reference in their entireties, except for the historical application documents inconsistent or conflicting with the content of this specification, and the documents (attached to this specification currently or later) that limit the widest scope of the claims of this specification. It is worthwhile to note that, if the description, definition, and/or use of the terms in the attachments of this specification are inconsistent or conflict with the content of this specification, the description, definition, or use of the terms of this specification shall prevail.

Finally, it should be understood that the embodiments described in this specification are merely used to describe the principles of the embodiments of this specification. Other variations may also fall within the scope of this specification. Therefore, by way of example instead of limitation, alternative configurations of the embodiments of this specification can be considered to be consistent with the teachings of this specification. Correspondingly, the embodiments of this specification are not limited to the embodiments expressly described in this specification.

1. A knowledge graph processing method, comprising:
selecting several nodes and their edges from a shared knowledge graph based on one or more entity types involved in a target service domain, to obtain a target subgraph, wherein the shared knowledge graph is obtained by fusing knowledge graphs of one or more service domains;
processing the target subgraph to extract one or more graph features, wherein the graph feature comprises some or all of the following: a node representation vector, an edge representation vector, a graph structure feature, a semantic feature of graph text information, and a graph rule feature; and
providing the graph feature to a target data processing task of the target service domain, wherein the graph feature is used to serve as an input feature of the target data processing task together with a task customization feature, so as to implement the target data processing task.

2. The method according to claim 1, wherein the graph structure feature comprises one or more of the following: degree information, a PageRank value, a node clustering coefficient, closeness centrality, eigenvector centrality, a common neighbor indicator, a Katz indicator, and random walk similarity.

3. The method according to claim 1, further comprising:
recalling several candidate nodes from the shared knowledge graph based on the target data processing task, wherein the candidate node is a processing object of the target data processing task;
wherein a recall manner comprises: querying the shared knowledge graph based on a retrieval condition to obtain the candidate node, or obtaining the candidate node from the shared knowledge graph through vector retrieval based on a target vector.

4. The method according to claim 1, wherein selecting several nodes and their edges from the shared knowledge graph based on one or more entity types involved in the target service domain, to obtain the target subgraph further comprises:
obtaining a macro feature of the target subgraph, wherein the macro feature comprises one or more of the following: a quantity of entities, degree distribution of a graph, connectivity distribution of a graph, and a data quality score of a graph; and
determining, based on the macro feature, whether the target subgraph satisfies a requirement, and upon determining that the target subgraph does not satisfy the requirement, modifying the target subgraph or re-obtaining a target subgraph from the shared knowledge graph.

5. The method according to claim 1, wherein the target subgraph is a heterogeneous graph; and processing the target subgraph to extract one or more graph features comprises:
splitting the target subgraph into a plurality of homogeneous graphs; and
separately processing the homogeneous graphs to extract one or more graph features.

6. The method according to claim 1, wherein the target data processing task is entity classification, inter-entity relationship prediction, or entity set mining.

7. (canceled)

8. (canceled)

9. (canceled)

10. (canceled)

11. (canceled)

12. (canceled)

13. A knowledge graph processing system, comprising a memory and a processor, wherein the memory stores executable instructions that, in response to execution by the processor, cause the processor to:
select several nodes and their edges from a shared knowledge graph based on one or more entity types involved in a target service domain, to obtain a target subgraph, wherein the shared knowledge graph is obtained by fusing knowledge graphs of one or more service domains;
process the target subgraph to extract one or more graph features, wherein the graph feature comprises some or all of the following: a node representation vector, an edge representation vector, a graph structure feature, a semantic feature of graph text information, and a graph rule feature; and
provide the graph feature to a target data processing task of the target service domain, wherein the graph feature is used to serve as an input feature of the target data processing task together with a task customization feature, so as to implement the target data processing task

14. A non-transitory computer-readable storage medium, comprising instructions stored therein that, when executed by a processor of a computing device, cause the processor to:
select several nodes and their edges from a shared knowledge graph based on one or more entity types involved in a target service domain, to obtain a target subgraph, wherein the shared knowledge graph is obtained by fusing knowledge graphs of one or more service domains;
process the target subgraph to extract one or more graph features, wherein the graph feature comprises some or all of the following: a node representation vector, an edge representation vector, a graph structure feature, a semantic feature of graph text information, and a graph rule feature; and
provide the graph feature to a target data processing task of the target service domain, wherein the graph feature is used to serve as an input feature of the target data processing task together with a task customization feature, so as to implement the target data processing task.
